(19) United States
(12) Patent Application Publication
(10) Pub. No.: US 2018/0006518 A1
(43) Pub. Date: Jan. 4, 2018

(54) ROBOT AND MOTOR

(71) Applicant: Seiko Epson Corporation, Tokyo (JP)

(72) Inventors: Satoru MASAI, Okaya (JP); Hiroshi MAKINO, Ina (JP); Shoji TAKAHASHI, Chino (JP)

(21) Appl. No.: 15/635,740

(22) Filed: Jun. 28, 2017

(30) Foreign Application Priority Data
Jun. 29, 2016 (JP) 2016-128520
Jul. 26, 2016 (JP) 2016-146028

(51) Int. Cl. H02K 3/18; B25J 9/12

(52) U.S. Cl. CPC H02K 3/18; B25J 9/126

(57) ABSTRACT

A robot includes a first member, a second member provided rotatably with respect to the first member, and a motor that transmits drive force from one to the other of the first member and the second member, wherein the motor has a stator having a bobbin and a winding wire wound around the bobbin, and a rotator rotatably attached to the stator, regarding the motor, a power supply voltage is within a range from 48 to 60 V, a wire diameter of the winding wire is within a range from 0.45 to 0.75 mm.

### BACKGROUND

### 1. Technical Field

The present invention relates to a robot and a motor.

### 2. Related Art

In related art, joining one second work grasped by one hand unit of a plurality of hand units of a robot hand to a joining part of a first work to be joined, then, integrally rotating the respective hand units, and thereby, positioning a second work grasped by the other hand unit closer to the joining part of the first work while separating the one hand unit from the first work are disclosed (for example, see Patent Document 1 (JP-A-2016-22563)).

Accordingly, when a job of sequentially joining a plurality of second works is performed, the number of times of a job of moving the hand unit to a set position for grasping the second works and a job of moving the hand unit from the set position to the first work may be reduced and the cycle time may be shortened.

When a magnet wire of a coil is wound in a regular condition and the ratio of the conductor portion to the section is larger, a motor with better efficiency is obtained. This is referred to as “space factor”, and optimal winding design is created in consideration of the wire diameter, number of turns, winding form (regular winding), and heat generation. Generally, regular winding is performed and the space factor of the coil is maximized.

For fabrication of the regularly-wound coil, various measures are taken, however, there is the following problem.

FIGS. 15 to 18 show fabrication steps of a regularly-wound coil of related art. FIG. 15 shows a state of the start of first turns of magnet wire 56. FIG. 16 shows a state of the start of second turns of magnet wire 58 (see FIG. 17) after the first turns of magnet wire 56 ends. FIG. 17 shows a state one turn before the second turns of magnet wire 58 ends.

A part 69 shown in FIG. 17 shows a state in which a portion one turn before the last of the winding of the second turns of magnet wire 58 drops out toward the first turns of magnet wire 56 side. The dropout occurs because the above described part one turn before the last of the second turns of magnet wire 58 falls into a triangular space 67 surrounded by a magnet wire 96 of an introduction part and a part of one turn of the first turns of magnet wire 56 shown in FIGS. 15 and 16. Due to the dropout, as shown in FIG. 18, the part of the last turn of the second turns of magnet wire 58 runs on the part one turn before the last, and the winding is irregular. The irregularity affects the third and subsequent turns and, consequently, regular winding becomes harder.

As means for solving the problem, a structure for guiding the magnet wire of the coil by providing a protruding wall in a flange part is disclosed (for example, see Patent Document 2 (JP-A-2006-67778)).

However, in Patent Document 1, the power supply voltage of the motor as a power source of the robot is a high voltage, and electrical and electronic components of the drive circuit system become expensive and the total price may be higher. Or, when the motor of related art is driven at a power supply voltage equal to or less than 60 V, there is a problem that the rotational speed decreases to one-fifth or less and realization of the target cycle time in the robot is impossible. As described above, in the motor of related art, it is hard to realize both the lower cost of the electrical and electronic components of the drive circuit system and the shorter cycle time.

Further, in the structure of Patent Document 2, the magnet wire interferes with the flange part in the coil end and the winding alignment may be irregular and the improvement of “space factor” may be harder.

### SUMMARY

Some aspects of the invention can be realized as the following embodiments or application examples.

### APPLICATION EXAMPLE 1

A robot according to the application example includes a first member, a second member provided rotatably with respect to the first member, and a motor that transmits drive force from one to the other of the first member and the second member, wherein the motor has a stator having a bobbin and a winding wire wound around the bobbin, and a rotator rotatably attached to the stator, regarding the motor, a power supply voltage is within a range from 48 to 60 V, a wire diameter of the winding wire is within a range from 0.45 to 0.75 mm, and a number of turns of the winding wire is within a range from 29 to 44.

According to the application example, the power supply voltage of the motor is within the range from 48 to 60 V, and thereby, general-purpose products may be used for the electrical and electronic components of the drive circuit system of the motor. Further, the wire diameter and the number of turns of the winding wire are controlled, and thereby, the rotational speed and torque of the motor may be controlled. Therefore, the lower cost of the motor and the higher performance of the motor may be realized. As a result, the robot may realize the lower cost and the shorter cycle time in the motor.

The test operation for measurements of the cycle time is reciprocation of the distal end portion of the coupled arms with a weight of 2 kg held in the distal end portion of the members of the robot (the distal end portion of the coupled arms) at the maximum velocities, maximum accelerations, maximum decelerations of the respective arms.

### APPLICATION EXAMPLE 2

In the robot according to the above described application example, it is preferable that output of the motor is within a range from 50 to 600 W.

According to the application example, preferable dimensions and sufficient output for the robot may be obtained using the motor.

### APPLICATION EXAMPLE 3

In the robot according to the above described application example, it is preferable that, when the output of the motor is within a range from 50 to 300 W, the wire diameter of the winding wire is within a range from 0.45 to 0.55 mm, and the number of turns of the winding wire is within a range from 29 to 43.

According to the application example, the output of the motor may be adjusted by adjustment of the number of turns of the winding wire.

### APPLICATION EXAMPLE 4

In the robot according to the above described application example, it is preferable that, when the output of the motor is within a range from 100 to 600 W, the wire diameter of the winding wire is within a range from 0.65 to 0.75 mm, and the number of turns of the winding wire is within a range from 34 to 44.

According to the application example, the output of the motor may be adjusted by adjustment of the wire diameter of the winding wire.

### APPLICATION EXAMPLE 5

In the robot according to the above described application example, it is preferable that a sum of a length of the first member and a length of the second member is equal to or less than 400 mm.

According to the application example, the sum of the length of the first member and the length of the second member may be secured to be longer.

### APPLICATION EXAMPLE 6

In the robot according to the above described application example, it is preferable that the robot is a scalar robot.

According to the application example, the scalar robot that may realize both the lower cost and the shorter cycle time may be provided.

### APPLICATION EXAMPLE 7

In the robot according to the above described application example, it is preferable that the robot is a multi-axis robot.

According to the application example, the multi-axis robot that may realize both the lower cost and the shorter cycle time may be provided.

### APPLICATION EXAMPLE 8

A motor according to the above described application example includes a stator having a bobbin and a winding wire wound around the bobbin, and a rotator rotatably attached to the stator, wherein, regarding the motor, a power supply voltage is within a range from 48 to 60 V, a wire diameter of the winding wire is within a range from 0.45 to 0.75 mm, and a number of turns of the winding wire is within a range from 29 to 44.

According to the application example, the power supply voltage of the motor is within the range from 48 to 60 V, and thereby, general-purpose products may be used for the electrical and electronic components of the drive circuit system of the motor. Further, the wire diameter and the number of turns of the winding wire are controlled, and thereby, the rotational speed and torque of the motor may be controlled. Therefore, the lower cost of the motor and the higher performance of the motor may be realized.

### APPLICATION EXAMPLE 9

A robot according to the application example includes a first member, a second member provided rotatably with respect to the first member, and a motor that transmits drive force from one to the other of the first member and the second member, wherein the motor has a bobbin, and the bobbin has a body around which a magnet wire is wound and a flange part located on an end of the body in an axis direction of winding, and the flange part has a concave portion opening toward the body side and a projecting portion projecting in a position adjacent to the concave portion and connecting to the body.

According to the application example, winding irregularities in the winding start part of the magnet wire in both directions of the axis direction of winding and the direction orthogonal thereto may be reduced by the concave portion. Further, the projecting portion projects by the amount of displacement between the first turns of magnet wire and the second turns of magnet wire, and deformation of the second turns of magnet wire to follow the bending shape of the first turns of magnet wire may be relaxed. Further, production of gaps between the magnet wires may be suppressed and the magnet wires can be aligned in the respective turns overlapping without gaps, and the bobbin that enables easier regular winding may be provided. Thereby, the motor with higher performance and higher efficiency having advantages of the above described bobbin may be obtained. As a result, the robot with higher performance and higher efficiency having advantages of the above described motor may be provided.

### APPLICATION EXAMPLE 10

In the robot according to the above described application example, it is preferable that the concave portion has a bottom part on an end side of the body with respect to an opening part in the axis direction of winding.

According to the application example, the magnet wire is inserted into the concave portion of the flange part from the opening part along the bottom part, and thereby, the magnet wire may be easily inserted into the concave portion.

### APPLICATION EXAMPLE 11

In the robot according to the above described application example, it is preferable that a width of the projecting portion in the axis direction of winding is within a range of ±20% with respect to a width of the magnet wire.

According to the application example, the width of the projecting portion in the axis direction of winding is set within the range of ±20% with respect to the width of the magnet wire, and thereby, alignment of the magnet wires in the respective turns overlapping without gaps may be reliably approached.

### APPLICATION EXAMPLE 12

In the robot according to the above described application example, it is preferable that a width of the projecting portion projecting from the body in a direction orthogonal to the axis direction of winding is within a range of ±20% with respect to the width of the magnet wire.

According to the application example, the width of the projecting portion projecting from the body in the direction orthogonal to the axis direction of winding is set within the range of ±20% with respect to the width of the magnet wire, and thereby, alignment of the magnet wires in the respective turns overlapping without gaps may be reliably approached.

### APPLICATION EXAMPLE 13

In the robot according to the above described application example, it is preferable that the projecting portion is provided along a winding direction of the body.

According to the application example, the projecting portion is provided along the winding direction of the body, and thereby, the projecting portion is put against the magnet wire at winding and stable winding may be performed.

### APPLICATION EXAMPLE 14

In the robot according to the above described application example, it is preferable that a section of the body has a rectangular shape and a length of the projecting portion in the winding direction of the body is within a range from 30 to 90% of a length of a short side of the rectangular shape.

According to the application example, the length of the projecting portion in the winding direction of the body is set within the range from 30 to 90% of the length of the short side of the rectangular shape, and thereby, alignment of the magnet wires in the respective turns overlapping without gaps may be reliably approached.

### APPLICATION EXAMPLE 15

A bobbin according to the application example includes a body around which a magnet wire is wound and a flange part located on an end of the body in an axis direction of winding, wherein the flange part has a concave portion opening toward the body side and a projecting portion projecting in a position adjacent to the concave portion and connecting to the body.

According to the application example, winding irregularities in the winding start part of the magnet wire in both directions of the axis direction of winding and the direction orthogonal thereto may be reduced by the concave portion. Further, the projecting portion projects by the amount of displacement between the first turns of magnet wire and the second turns of magnet wire, and deformation of the second turns of magnet wire to follow the bending shape of the first turns of magnet wire may be relaxed. Further, production of gaps between the magnet wires may be suppressed and the magnet wires can be aligned in the respective turns overlapping without gaps, and the bobbin that enables easier regular winding may be provided.

### APPLICATION EXAMPLE 16

A method of manufacturing a coil bobbin according to the application example is a method of manufacturing a coil bobbin having a body and a flange part located on an end of the body in an axis direction of winding, the flange part having a concave portion opening toward the body side and a projecting portion projecting in a position adjacent to the concave portion and connecting to the body, and a magnet wire wound around the body, including a step of inserting the magnet wire into the concave portion and a step of winding the magnet wire around the projecting portion.

According to the application example, winding irregularities in the winding start part of the magnet wire in both directions of the axis direction of winding and the direction orthogonal thereto may be reduced by the concave portion. Further, the projecting portion projects by the amount of displacement between the first turns of magnet wire and the second turns of magnet wire, and deformation of the second turns of magnet wire to follow the bending shape of the first turns of magnet wire may be relaxed. Furthermore, production of gaps between the magnet wires may be suppressed and the magnet wires can be aligned in the respective turns overlapping without gaps, and regular winding may be easily performed. In addition, winding of the second turns of magnet wire may be smoothly performed, and efficient winding operation may be performed without stoppage of the winding machine. Thereby, the method of manufacturing the coil bobbin with higher performance and higher efficiency may be provided.

### BRIEF DESCRIPTION OF THE DRAWINGS

The invention will be described with reference to the accompanying drawings, wherein like numbers reference like elements.

FIG. 1 shows an example of a configuration of a robot according to the first embodiment.

FIG. 2 is a perspective view of an example of a motor unit.

FIG. 3 is a sectional view showing a motor according to the first embodiment.

FIG. 4 shows a structure of a bobbin.

FIG. 5 shows TN characteristics of operations of the motor and the robot when output of the motor is specified for 200 W.

FIG. 6 shows TN characteristics of operations of the motor and the robot when the output of the motor is specified for 100 W.

FIG. 7 shows a schematic configuration of a robot according to the second and third embodiments.

FIG. 8 is a partially enlarged perspective view showing a structure of a bobbin according to the third embodiment.

FIG. 9 is a schematic plan view of the bobbin according to the third embodiment as seen from a direction of an arrow A in FIG. 8.

FIG. 10 is a schematic side view of the bobbin according to the third embodiment as seen from a direction of an arrow B in FIG. 8.

FIG. 11 is a schematic side view of the bobbin according to the third embodiment as seen from a direction of an arrow C in FIG. 8.

FIG. 12 shows a fabrication step of a coil bobbin according to the third embodiment.

FIG. 13 shows a fabrication step of the coil bobbin according to the third embodiment.

FIG. 14 shows a fabrication step of the coil bobbin according to the third embodiment.

FIG. 15 shows a fabrication step of a regularly-wound coil of related art.

FIG. 16 shows a fabrication step of the regularly-wound coil of related art.

FIG. 17 shows a fabrication step of the regularly-wound coil of related art.

FIG. 18 shows a fabrication step of the regularly-wound coil of related art.

### DESCRIPTION OF EXEMPLARY EMBODIMENTS

As below, embodiments of the invention will be explained with reference to the drawings. Note that the drawings for use are appropriately enlarged or reduced so that the parts to be explained can be recognized.

A robot according to the embodiments may perform works of feeding, removing, carrying, and assembly of precise apparatuses and components forming the apparatuses (objects).

### First Embodiment

### Configuration of Robot

A configuration of a robot 1 according to the embodiment will be explained.

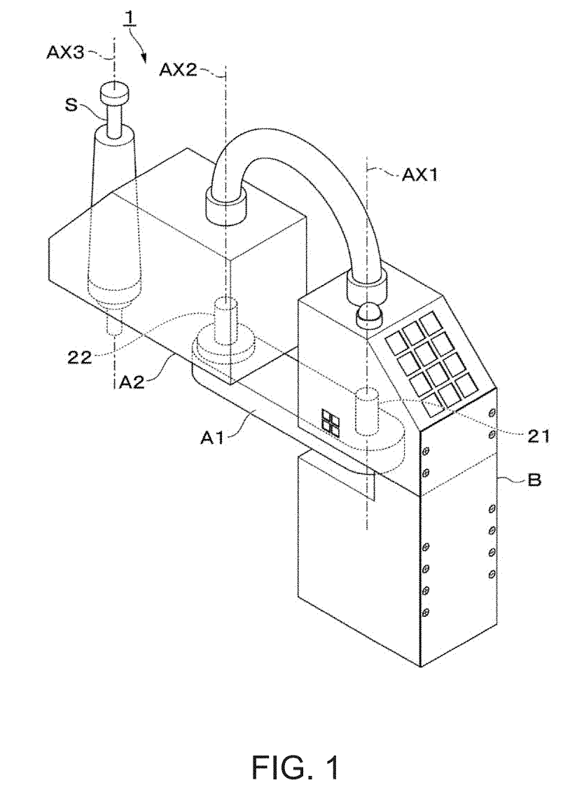

FIG. 1 shows an example of the configuration of the robot 1 according to the embodiment.

The robot 1 according to the embodiment is a scalar robot including a support B installed on an installation surface such as a floor surface or wall surface, a first arm A1 as a first member supported to be rotatable about a first axis AX1 by the support B, a second arm A2 as a second member supported to be rotatable about a second axis AX2 by the first arm A1, a shaft S supported to be rotatable about a third axis AX3 and translationable in an axis direction of the third axis AX3 by the second arm A2. According to the configuration, the scalar robot that may realize both the lower cost and the shorter cycle time may be provided.

Note that the robot 1 may be another robot such as a vertical articulated robot or Cartesian coordinate robot in place of the scalar robot. The vertical articulated robot may be a single-arm robot having a single arm, a dual-arm robot having two arms (a multi-arm robot including two arms), or a multi-arm robot including three or more arms. Further, the Cartesian coordinate robot is e.g. a gantry robot.

The shaft S is a shaft body having a circular cylindrical shape. In the circumferential surface of the shaft S, a ball screw groove and a spline groove (not shown) are respectively formed. In the example, the shaft S is provided to penetrate the opposite end to the first arm A1 of the ends of the second arm A2 in a first direction as a direction perpendicular to the installation surface on which the support B is installed. An end effector can be attached to an end on the installation surface side of the ends of the shaft S. The end effector may be an end effector that can grasp an object, an end effector that attracts an object by air or magnetic force, or another end effector.

In the example, the first arm A1 rotates about the first axis AX1, and thereby, moves in a second direction. The second direction is a direction orthogonal to the above described first direction. The second direction is e.g. a direction along an XY-plane in a world coordinate system or robot coordinate system RC. The first arm A1 is rotated about the first axis AX1 using a motor unit 21 of the support B. The output of a motor 4 of the motor unit 21, which will be described later, is preferably within a range from 100 to 600 W. The output is more preferably 200 W. Here, the output of the motor 4 changes according to a radiation condition or the like, for example.

In the example, the second arm A2 rotates about the second axis AX2, and thereby, moves in the second direction. The second arm A2 is rotated about the second axis AX2 using a motor unit 22 of the second arm A2. Further, the second arm A2 includes a motor unit 23 (not shown) and a motor unit 24 (not shown) and supports the shaft S. The motor unit 23 turns a ball screw nut provided on the outer circumference part of the ball screw groove of the shaft S with a timing belt or the like, and thereby, moves (up and down) the shaft S in the first direction. The motor unit 24 turns a ball spline nut provided on the outer circumference part of the ball spline groove of the shaft S with a timing belt or the like, and thereby, rotates the shaft S about the third axis AX3. The outputs of motors 4 of the motor units 22 to 24 are preferably within a range from 50 to 300 W and more preferably 100 W. Here, the outputs of the motors 4 change according to the radiation condition or the like, for example. The motor 4 transmits drive power from one to the other of the first arm A1 and the second arm A2.

The sum of the length of the first arm A1 and the length of the second arm A2 is preferably equal to or less than 400 mm. Accordingly, the sum of the length of the first arm A1 and the length of the second arm A2 may be secured to be longer. For example, the length of the first arm A1 is 225 mm, the length of the second arm A2 is 175 mm, and the sum of the length of the first arm A1 and the length of the second arm A2 is 400 mm in distance between axis centers.

As below, as an example, the case where all of the respective motor units 21 to 24 have the same configuration will be explained. Note that part or all of the motor units 21 to 24 may be motor units having different configurations from one another. As below, the motor units will be collectively referred to as “motor unit 2” unless it is necessary to distinguish the respective motor units 21 to 24.

### Configuration of Motor Unit

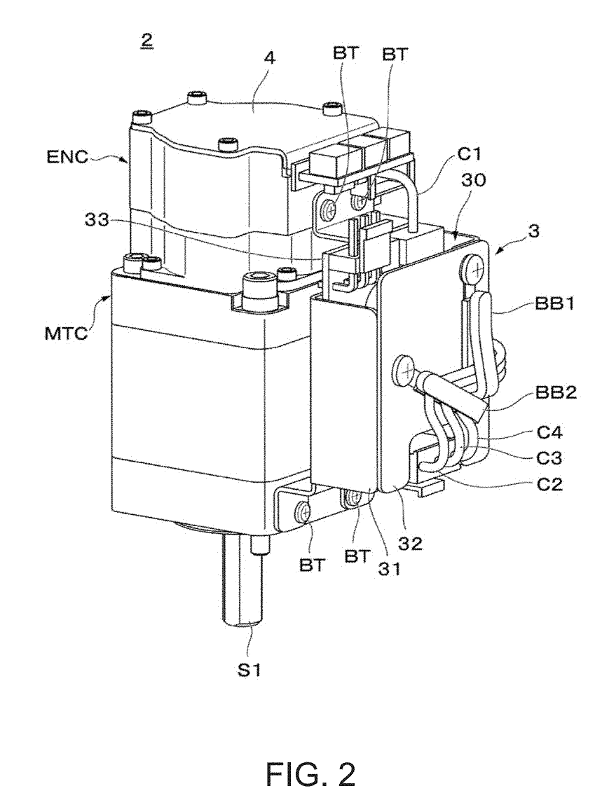

As below, the configuration of the motor unit 2 will be explained with reference to FIG. 2.

FIG. 2 is a perspective view of an example of the motor unit 2. As shown in FIG. 2, the motor unit 2 includes the motor 4 and an amplifier part 3.

The amplifier part 3 includes a drive circuit that drives the motor 4, a control circuit that controls the drive circuit, and a communication circuit. Here, an overview of the motor unit 2 is explained. The motor unit 2 includes the motor 4 and the amplifier part 3 having the drive circuit that drives the motor 4. The amplifier part 3 includes an amplifier cover 32. A power line for supplying electric power to the motor 4 is bound to the amplifier cover 32. Thereby, the motor unit 2 may suppress interferences of the power line with other objects. As below, the motor unit 2 will be explained in detail. Further, as below, as an example, the case where the motor 4 is a motor integrated with an encoder ENC (not shown in FIG. 1) will be explained. Note that the motor 4 may be a motor separated from the encoder ENC.

As below, for convenience of explanation, a direction from the opposite side to a motor top case MTC toward the motor top case MTC of directions along a rotation shaft S1 of the motor 4 will be referred to as “upward direction” and a direction from the motor top case MTC toward the opposite side will be referred to as “downward direction”. The motor top case MTC is a member provided on an end on the opposite side to the side on which the rotation shaft S1 of the motor 4 projects of the ends of the motor 4. Here, the above described encoder ENC is provided on an end on the opposite side to the side on which the rotation shaft S1 of the motor 4 projects of the ends of the motor top case MTC. Further, as below, the side surface to which the amplifier part 3 is attached of the side surfaces (surfaces parallel to the upward and downward directions) of the motor 4 is referred to as “front surface”, the side surface opposed to the front surface is referred to as “back surface”, the side surface located on the right side when the motor 4 is seen toward the front surface is referred to as “right surface”, and the side surface opposed to the right surface is referred to as “left surface”.

In the motor unit 2, the amplifier part 3 is attached to the front surface of the motor 4. As below, as an example, the case where the motor 4 is a three-phase direct-current motor will be explained. Note that the motor 4 may be another motor instead. The amplifier part 3 amplifies the electric power supplied via a board of the motor 4 and operates the motor 4 according to a control signal supplied via the board. Specifically, when operating the motor 4, the amplifier part 3 supplies electric power to the respective electromagnets for three phases of the motor 4 at times according to the control signal. As below, for convenience of explanation, the respective three phases will be referred to as “U-phase”, “V-phase”, and “W-phase”.

The amplifier part 3 supplies electric power to the U-phase electromagnet of the motor 4 using a power line C2. That is, the power line C2 is a power line connecting the amplifier part 3 and the U-phase electromagnet of the motor 4. Further, the amplifier part 3 supplies electric power to the V-phase electromagnet of the motor 4 using a power line C3. That is, the power line C3 is a power line connecting the amplifier part 3 and the V-phase electromagnet of the motor 4. Furthermore, the amplifier part 3 supplies electric power to the W-phase electromagnet of the motor 4 using a power line C4. That is, the power line C4 is a power line connecting the amplifier part 3 and the W-phase electromagnet of the motor 4.

Electric power is supplied to the amplifier part 3 from the board of the motor 4 by a power line passing through a tube C1. Electric power is supplied to the board from a power supply (not shown) and the board supplies the supplied electric power to the amplifier part 3 using the power line. A control signal is supplied to the amplifier part 3 from the board of the motor 4 by a communication line passing through the tube C1. A control signal is supplied to the board from a robot control apparatus (not shown) and the board supplies the supplied control signal to the amplifier part 3 using the communication line. The robot control apparatus is an apparatus that controls the robot 1.

The amplifier part 3 includes a structure having an amplifier board 33 housed within a housing part 30. The amplifier board 33 is a board including the above described drive circuit, control circuit, and communication circuit. In the example, the housing part 30 includes a radiation member 31 forming a partition wall portion on the back side of the housing part 30, a partition wall portion on the left side of the housing part 30, and a partition wall portion on the right side of the housing part 30, and the amplifier cover 32 fixed to the radiation member 31, but not include a partition wall portion on the upside or a partition wall portion on the downside. In the partition wall portion on the back side of the housing part 30, the amplifier board 33 is provided (fixed) in the housing part 30. The housing part 30 does not have the partition wall portion on the upside or partition wall portion on the downside, and thereby, the housing part 30 may radiate heat of the amplifier part 3 (i.e., heat of the amplifier board 33) by air passing through the housing part 30.

The radiation member 31 is an attachment portion that can be attached to the front surface of the motor 4 by bolts BT. Thereby, the motor unit 2 may integrate the motor 4 and the amplifier part 3. Through holes for penetration of the bolts BT are formed in the attachment portion. In the example shown in FIG. 2, the radiation member 31 is attached to the front surface of the motor 4 by the attachment portion and the four bolts BT. Note that the radiation member 31 may have a configuration attached to the front surface of the motor 4 by another attachment jig or attachment mechanism than the bolts BT in place of the configuration attached to the front surface of the motor 4 by the bolts BT. Or, the radiation member 31 may have a configuration attached to the other side surface of the motor 4 in place of the front surface of the motor 4.

The amplifier cover 32 is a cover that covers the front surface of the housing part 30. The above described power line C2, power line C3, and power line C4 are bound to the amplifier cover 32. Thereby, the motor unit 2 may suppress interferences of the respective power line C2, power line C3, and power line C4 with other objects. Further, the motor unit 2 may suppress bending of the respective power line C2, power line C3, and power line C4 over the maximum bend radiuses and enable a user to easily assemble the motor unit 2.

Specifically, a first binding portion BB1 and a second binding portion BB2 are attached to the front surface of the amplifier cover 32, i.e., the outside of the amplifier cover 32.

The first binding portion BB1 is a member that binds the respective power line C2, power line C3, and power line C4 connected from the amplifier board 33 to the motor 4 in positions closer to the connection positions in which the power line C2, power line C3, and power line C4 are connected to the motor 4 than the second binding portion BB2, e.g. a binding clip. In the example, the first binding portion BB1 is attached to the amplifier cover 32 by a screw.

The second binding portion BB2 is a member that binds the respective power line C2, power line C3, and power line C4 connected from the amplifier board 33 to the motor 4 in positions closer to the connection positions in which the power line C2, power line C3, and power line C4 are connected to the amplifier board 33 than the first binding portion BB1, e.g. a binding clip. In the example, the second binding portion BB2 is attached to the amplifier cover 32 by a screw.

### Motor

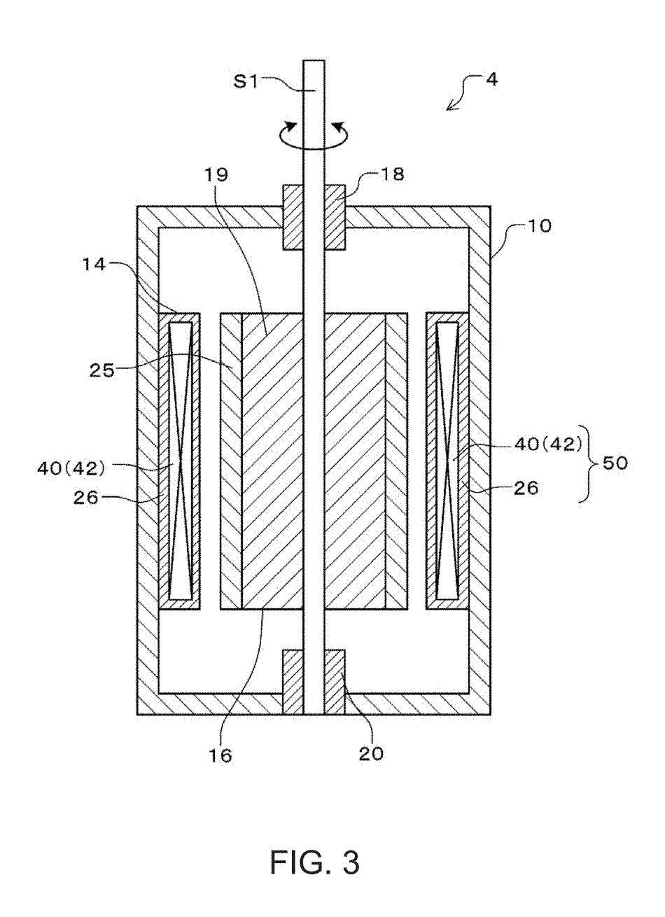

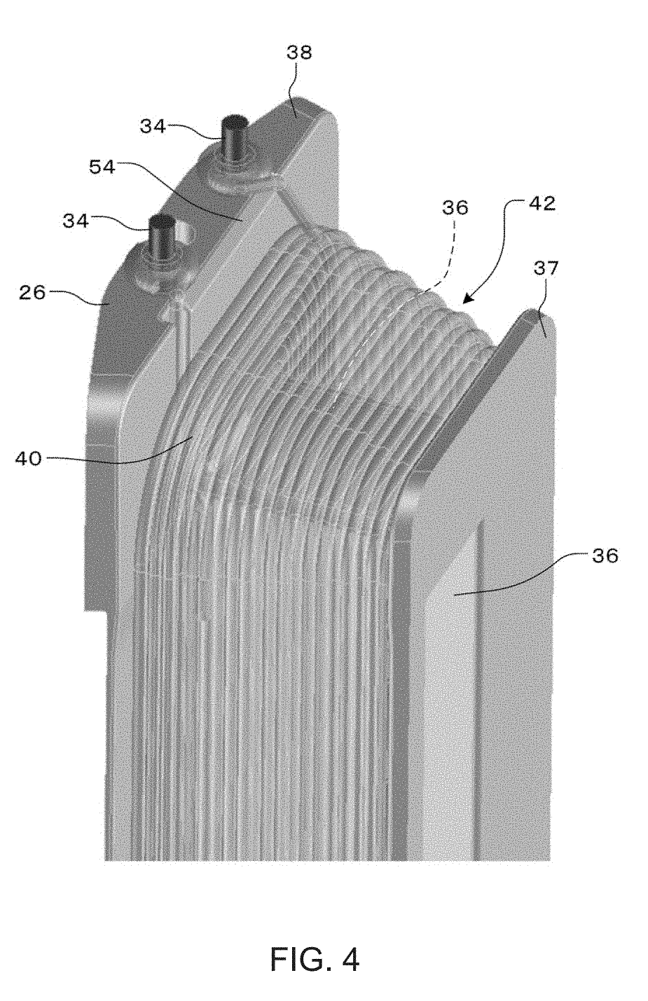

FIG. 3 is a sectional view showing the motor 4 according to the embodiment. FIG. 4 shows a structure of a bobbin 26.

As shown in FIG. 3, the motor 4 according to the embodiment includes a housing 10, the rotation shaft S1, a stator 14, and a rotor 16. Note that the motor 4 includes, but is not particularly limited to, e.g. a servo motor and stepping motor.

Bearings 18, 20 are provided in the upper wall and the bottomwall of the housing 10. The rotation shaft (rotating shaft) S1 is rotatably supported by the bearings 18, 20. Or, within the housing 10, the rotor 16 is fixed to the rotation shaft S1. The rotor 16 has a cylindrical shape and includes a core 19 formed using a soft magnetic material such as iron and a permanent magnet 25 provided on the outer circumference of the core 19. Further, the stator 14 is provided around the rotor 16. The material of the housing 10 is e.g. a conductive metal. The permanent magnet 25 has an annular column shape. Further, the permanent magnet 25 has a multipolar structure in which a plurality of magnetic poles are formed in the circumferential direction.

As shown in FIG. 4, the stator 14 according to the embodiment includes a coil 42 formed by winding of a winding wire 40 around the bobbin 26, pins 34 around which the winding wire 40 is looped, and a coil connection board (not shown) that electrically connects the coil 42. Apart of the winding wire 40 according to the embodiment is provided between the coil connection board and an end surface 54 of the bobbin 26.

The bobbin 26 includes a tubular core part (winding part (body)) 36 covering the outer circumferential surface of a teeth (not shown) and first and second flange parts 37, 38 expanding in radial directions on both ends of the core part 36. The bobbin 26 includes the tubular core part 36 provided outside of the teeth, around which the winding wire 40 is wound, the first flange part 37 extending from the core part 36 inward in the radial directions and the second flange part 38 extending from the core part 36 outward in the radial directions. The pins 34 are fixed to the second flange part 38. The second flange part 38 of the bobbin 26 is continuously provided on the core part 36.

The wire diameter of the winding wire 40 of the motor 4 is within a range from 0.45 to 0.75 mm. The number of turns of the winding wire 40 of the motor 4 is within a range from 29 to 44.

The power supply voltage of the motor 4 is within a range from 48 to 60 V. The output of the motor 4 is within a range from 50 to 600 W. According to the configuration, preferable dimensions and sufficient output for the robot 1 may be obtained using the motor 4.

### EXAMPLES

The example takes an example of the case where the motor 4 for which the power supply voltage of the motor 4 is 48 V, 52 V and 60 V equal to or less than 60 V is incorporated in the robot 1.

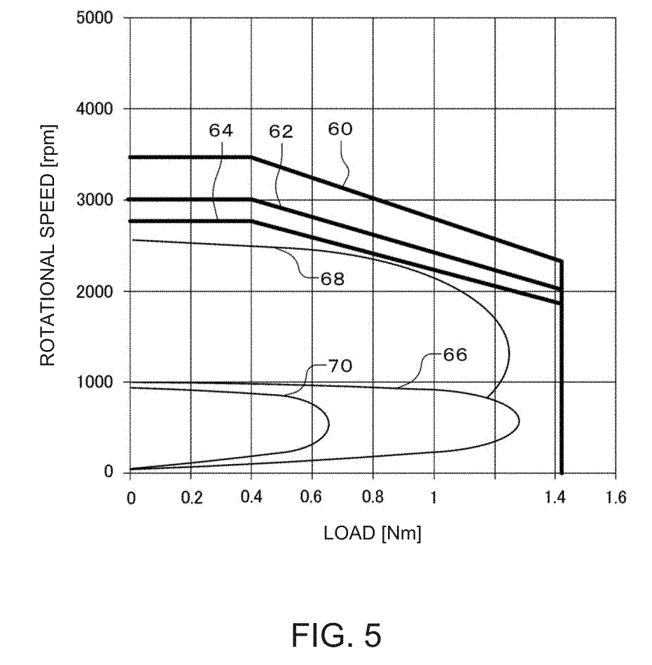

FIG. 5 shows TN characteristics operations of the motor 4 and the robot 1 when the output of the motor 4 is specified for 200 W.

In the example, when the output of the motor 4 is specified for 200 W, the wire diameter of the winding wire 40 is within a range from 0.65 to 0.75 mm. The number of turns of the winding wire 40 is within a range from 34 to 44. According to the configuration, the output of the motor 4 may be adjusted by adjustment of the wire diameter of the winding wire 40. For example, when the output is 200 W and the power supply voltage is equal to or less than 60 V, the wire diameter of the winding wire 40 is 0.70 mm and the number of turns of the winding wire 40 is 39.

A polygonal line 60 shown in FIG. 5 shows the TN characteristics of the motor 4 when the motor 4 is driven at the power supply voltage of 60 V. A polygonal line 62 shows the TN characteristics of the motor 4 when the motor 4 is driven at the power supply voltage of 52 V. A polygonal line 64 shows the TN characteristics of the motor 4 when the motor 4 is driven at the power supply voltage of 48 V.

A curved line 66 shows the TN characteristics of the motor 4 when standard operation of the robot 1 having the motor 4 is performed, and the standard operation cycle time is 0.54 s. A curved line 68 shows the TN characteristics of the motor 4 when P&P operation (long pitch) of the robot 1 having the motor 4 is performed, and the cycle time is 1.56 s. Note that a curved line 70 shows the TN characteristics of the motor 4 when standard operation of the robot having the motor of related art is performed, and the cycle time is 0.64 s.

When the motor 4 of the example is driven at the power supply voltages of 48 V, 52 V, and 60 V, the TN characteristics that realize the standard operation cycle time of 0.54 s is obtained in any case. Further, when the motor 4 of the example is driven at the power supply voltages of 48 V, 52 V, and 60 V, the TN characteristics that realize the P&P operation (long pitch) cycle time of 1.56 s is obtained in any case.

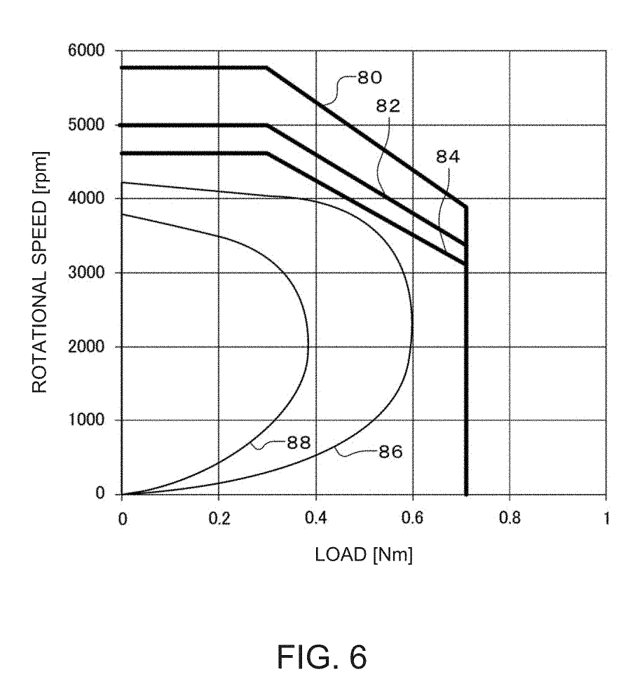

FIG. 6 shows TN characteristics of operations of the motor 4 and the robot 1 when the output of the motor 4 is specified for 100 W.

In the example, when the output of the motor 4 is specified for 100 W, the wire diameter of the winding wire 40 is within a range from 0.45 to 0.55 mm. The number of turns of the winding wire 40 is within a range from 29 to 43. According to the configuration, the output of the motor 4 may be adjusted by adjustment of the number of turns of the winding wire 40. For example, when the output is 100 W and the power supply voltage is equal to or less than 60 V, the wire diameter of the winding wire 40 is 0.50 mm and the number of turns of the winding wire 40 is 36.

A polygonal line 80 shown in FIG. 6 shows the TN characteristics of the motor 4 when the motor 4 is driven at the power supply voltage of 60 V. A polygonal line 82 shows the TN characteristics of the motor 4 when the motor 4 is driven at the power supply voltage of 52 V. A polygonal line 84 shows the TN characteristics of the motor 4 when the motor 4 is driven at the power supply voltage of 48 V.

A curved line 86 shows the TN characteristics of the motor 4 when standard operation of the robot 1 having the motor 4 is performed, and the standard operation cycle time is 0.54 s. A curved line 88 shows the TN characteristics of the motor when standard operation of the robot having the motor of related art is performed, and the cycle time is 0.64 s.

When the motor 4 of the example is driven at the power supply voltages of 48 V, 52 V, and 60 V, the TN characteristics that realize the standard operation cycle time of 0.54 s is obtained in any case.

The features of the robot 1 on which the motor 4 of the example is mounted are an arm length of 400 mm, a portable mass of 1 kg, the power supply voltage within the range from 48 to 60 V, and the standard operation cycle time of 0.54 s. Thereby, the cost of the electrical and electronic components of the drive circuit system of the motor 4 may be significantly reduced.

Note that, in the respective operations, all of the first axis AX1 to the third axis AX3 move and the first axis AX1 and the second axis AX2 dominate the operation time.

The test operation for the measurements of the standard operation cycle time is reciprocation of the distal end portion of the coupled arms with a weight of 2 kg held in the distal end portion of the members of the robot (the distal end portion of the coupled arms) at the maximum velocities, maximum accelerations, maximum decelerations of the respective arms.

In the outward path and the return path in the reciprocation, an upward operation of moving the distal end portion of the coupled arms upward in the vertical direction by 25 mm are performed, a horizontal movement operation of moving the distal end in the horizontal direction by 300 mm, and a downward operation of moving the distal end upward in the vertical direction by 25 mm, and the initial parts of the upward operation and the horizontal movement operation are performed at the same time and the ending parts of the downward operation and the horizontal movement operation are performed at the same time. Further, in the P&P operation (long pitch), the movement distance in the horizontal direction is 900 mm.

According to the embodiment, the power supply voltage is set within the range from 48 to 60 V, and thereby, general-purpose products may be used for the electrical and electronic components of the drive circuit system of the motor 4. Further, the wire diameter and the number of turns of the winding wire 40 are controlled, and thereby, the rotational speed and torque of the motor 4 may be controlled. Therefore, the lower cost of the motor 4 and the higher performance of the motor 4 may be realized. As a result, the robot 1 may realize the lower cost and the shorter cycle time in the motor 4.

### Second Embodiment

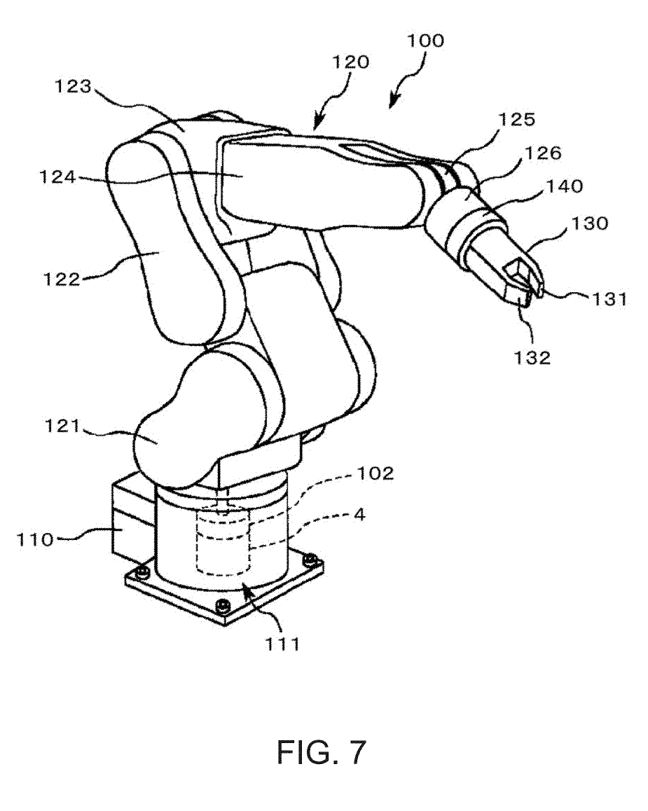

As below, a structure of a robot of the embodiment will be explained with reference to FIG. 7.

FIG. 7 shows a schematic configuration of a robot 100 according to the embodiment.

The robot 100 according to the embodiment is different from that of the first embodiment in that the robot is a multi-axis robot. As below, the same configuration parts as those of the first embodiment have the same signs and their explanation are omitted or simplified here.

As shown in FIG. 7, the robot 100 of the embodiment includes the motor 4 as is the case of the first embodiment.

The robot 100 according to the embodiment is a six-axis vertical articulated robot, and includes a base 111 as the first member, a robot arm 120 connected to the base 111, and a force detector 140 and a hand 130 provided on the distal end part of the robot arm 120. Further, the robot 100 includes a control apparatus 110 that controls a plurality of drive sources (including the motor 4 and a gear device 102) that generate power for driving the robot arm 120.

The base 111 is a part for attaching the robot 100 to an arbitrary installation location. Note that the installation location of the base 111 includes, but is not limited to, e.g. a floor, wall, ceiling, and movable platform.

The robot arm 120 includes a first arm (arm) 121 as the second member, a second arm (arm) 122, a third arm (arm) 123, a fourth arm (arm) 124, a fifth arm (arm) 125, and a sixth arm (arm) 126. These arms are sequentially coupled from the proximal end side toward the distal end side. The first arm 121 is connected to the base 111. The first arm 121 includes an arm and is provided rotatably with respect to the base 111. The motor 4 transmits drive force from one to the other of the base 111 and the first arm 121. The motor 4 transmits drive force from the base 111 to the first arm 121. The motor 4 transmits drive force from the first arm 121 to the base 111. The motor 4 rotates the first arm 121 with respect to the base 111. For example, a hand 130 (end effector) that grasps various components or the like is detachably attached to the distal end of the sixth arm 126. The hand 130 includes two fingers 131, 132 and may grasp e.g. various components or the like with the two fingers 131, 132.

In the base 111, a drive source including the motor 4 such as a servo motor that drives the first arm 121 and the gear device 102 (reducer) is provided. Further, a plurality of drive sources including motors and reducers (not shown) are provided in the respective arms 121 to 126. The respective drive sources are controlled by the control apparatus 110.

In the robot 100, the gear device 102 transmits drive force from one to the other of the base 111 and the first arm 121. More specifically, the gear device 102 transmits drive force for rotating the first arm 121 with respect to the base 111 from the base 111 side toward the first arm 121 side. Here, the gear device 102 functions as a reducer, and thereby, may reduce the drive power and rotate the first arm 121 with respect to the base 111. Note that “rotation” includes motion in both directions containing one direction and the opposite direction thereto with respect to a certain center point and rotation with respect to a certain center point.

In the embodiment, the base 111 is “first member” and the first arm 121 is “second member” containing the arm and provided rotatably with respect to the base 111 as the first member. Note that “second member” may include arms in an arbitrary number selected from the second to sixth arms 122 to 126 sequentially from the first arm 121 side. That is, a structure including the first arm 121 and the arms in an arbitrary number selected from the second to sixth arms 122 to 126 sequentially from the first arm 121 side may be referred to as “second member”. For example, the structure including the first and second arms 121, 122 may be referred to as “second member”, or the whole robot arm 120 may be referred to as “second member”. Or, “second member” may include the hand 130. That is, a structure including the robot arm 120 and the hand 130 may be referred to as “second member”.

According to the embodiment, the multi-axis robot that may realize both the lower cost and the shorter cycle time may be provided.

### Third Embodiment

Next, a robot 100 according to the embodiment will be explained. The robot 100 of the embodiment includes a motor 4, which will be described later. As below, the motor 4 according to the embodiment will be explained with a focus on the differences from the motor 4 of the above described first embodiment. Further, the same configurations have the same signs and the explanation of the same items will be omitted or simplified.

### Motor

As shown in FIG. 3, the motor 4 according to the embodiment includes a housing 10, a stator 14 having a bobbin 26, and a rotor 16. The following description and drawings of the embodiment will be made with an inner rotor structure in which the rotor 16 is provided inside of the stator 14.

The stator 14 is provided around the rotor 16. The stator 14 has a cylindrical shape and includes a coil bobbin 50 having a plurality of bobbins 26 provided at predetermined intervals in the circumferential direction and a plurality of coils 42 wound around the bobbins.

The coil 42 is formed by a regularly wound magnet wire (winding wire) 40. The magnet wire 40 is insulated. The magnet wire 40 is e.g. a polyurethane copper wire, polyester copper wire, polyester imide copper wire, polyamide imide copper wire, or polyimide copper wire. The magnet wire 40 includes first turns of magnet wire 56 formed by winding of the wire on a body (core portion) 36 and second turns of magnet wire 58 formed by winding the wire on the first turns of magnet wire 56 (see FIG. 13).

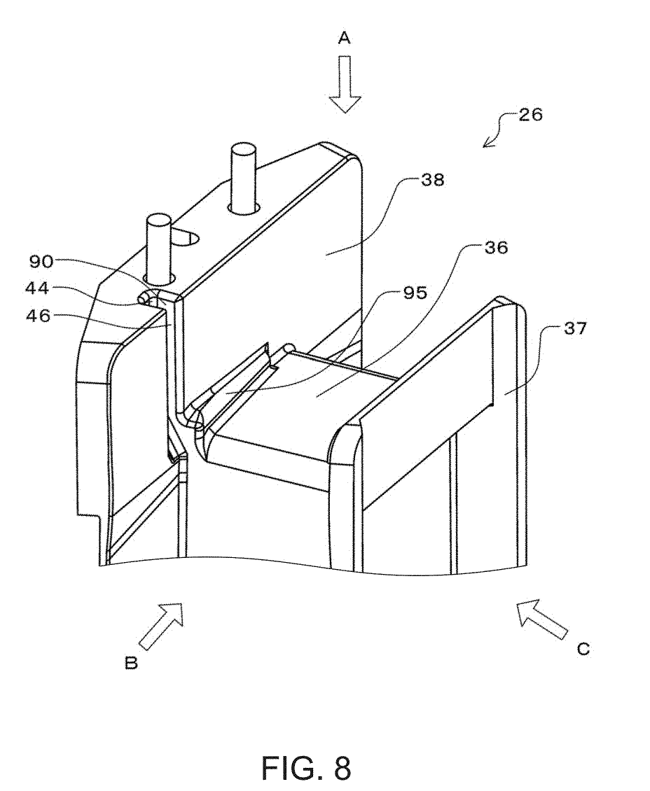

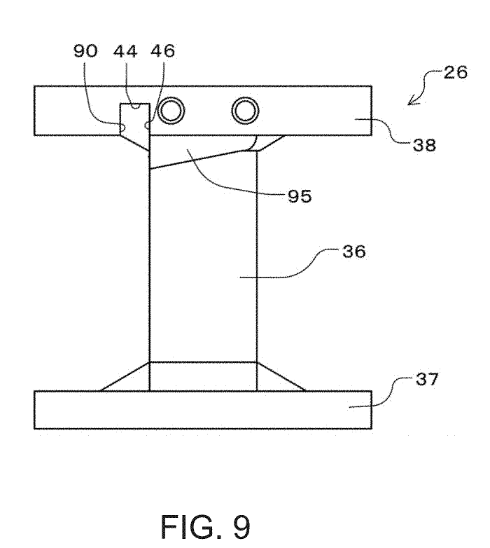

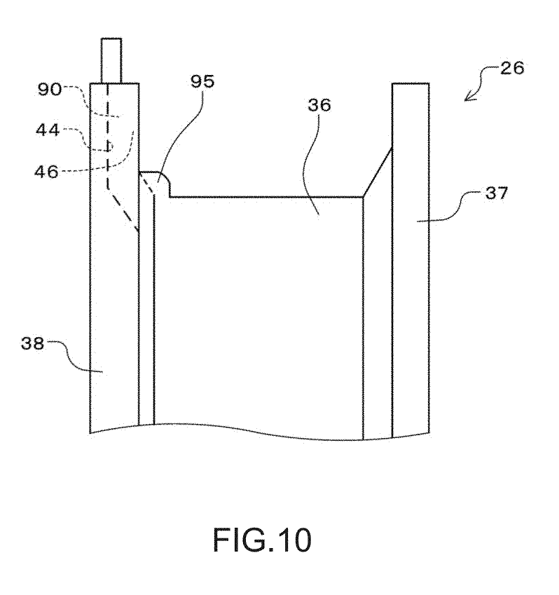

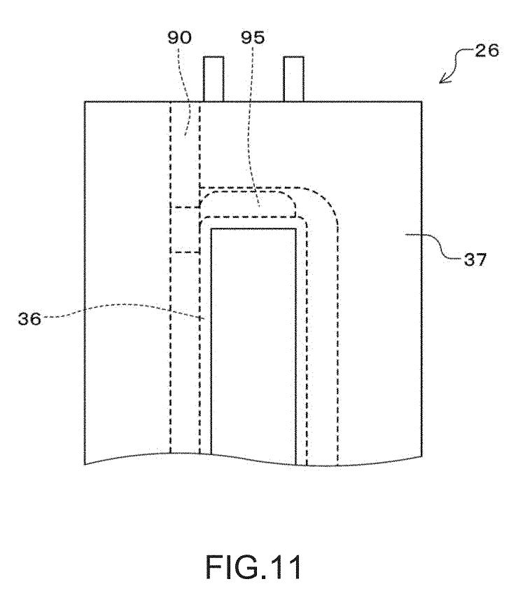

FIG. 8 is a partially enlarged perspective view showing a structure of the bobbin 26 according to the embodiment. FIG. 9 is a schematic plan view of the bobbin 26 according to the embodiment as seen from a direction of an arrow A in FIG. 8, FIG. 10 is a schematic side view of the bobbin 26 according to the embodiment as seen from a direction of an arrow B in FIG. 8, and FIG. 11 is a schematic side view of the bobbin 26 according to the embodiment as seen from a direction of an arrow C in FIG. 8.

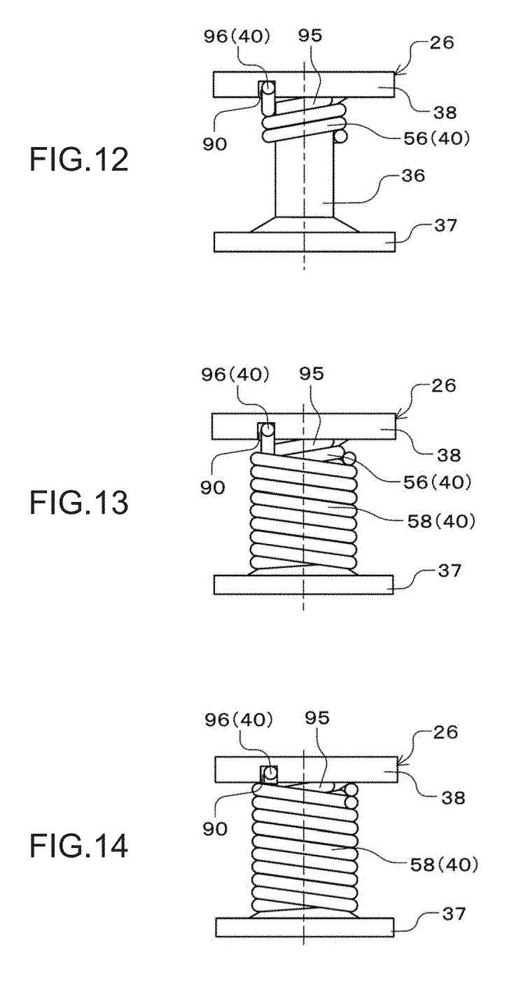

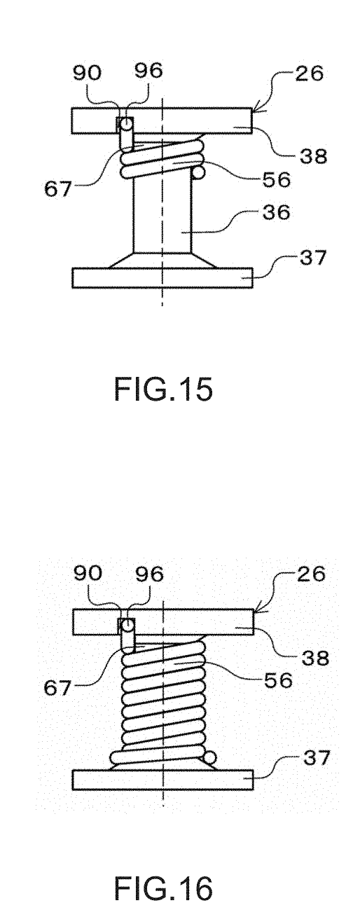

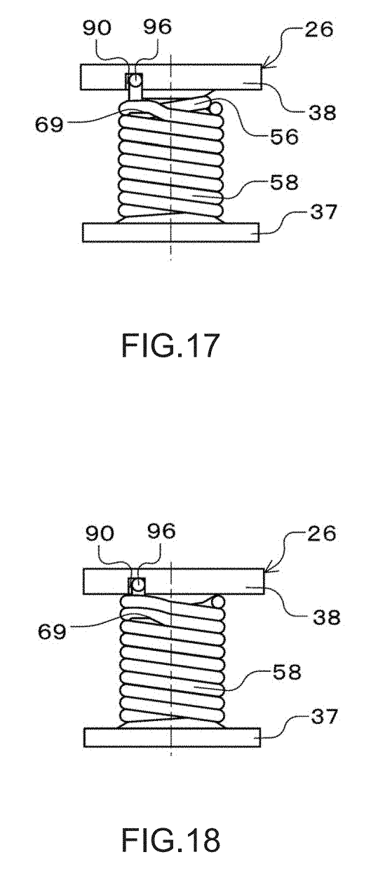

The bobbin 26 according to the embodiment includes the body 36 around which the magnet wire 40 (see FIG. 12) is wound and first and second flange parts 37, 38 respectively formed on the outer circumference surface of the body 36 for restricting the magnet wire 40.

The first and second flange parts 37, 38 are provided on the ends of the body 36. The first and second flange parts 37, 38 are provided on the ends of the body 36 in the axis direction of winding in which the magnet wire 40 is wound. The first and second flange parts 37, 38 are provided on both ends of the body 36 in the axis direction of winding in which the magnet wire 40 is wound.

In the second flange part (flange part) 38, a concave portion 90 and a projecting portion 95 are provided. The concave portion 90 opens toward the body 36 side. The concave portion 90 has an opening part 46. The concave portion 90 has a bottom part 44. The concave portion 90 has the bottom part 44 on the end side of the body 36 with respect to the opening part 46 in the axis direction of winding in which the magnet wire 40 is wound. According to the configuration, the magnet wire 40 is inserted into the concave portion 90 of the second flange part 38 from the opening part 46 along the bottom part 44, and thereby, the magnet wire 40 may be easily inserted into the concave portion 90.

It is preferable that the width in the axis direction of winding of the projecting portion 95 is within a range of ±20% with respect to the width of the magnet wire 40. It is preferable that the width of the magnet wire 40 is within a range of ±20% with respect to the width of the projecting portion 95 in the axis direction of winding. According to the configuration, the width of the projecting portion 95 in the axis direction of winding is set within the range of ±20% with respect to the width of the magnet wire 40, and thereby, alignment of the magnet wires 40 in the respective turns overlapping without gaps may be reliably approached.

It is preferable that the height of the projecting portion 95 (the width projecting from the body in a direction orthogonal to the axis direction of winding) is within a range of ±20% with respect to the width of the magnet wire 40. It is preferable that the width of the magnet wire 40 is within a range of ±20% with respect to the height of the projecting portion 95. According to the configuration, the height of the projecting portion 95 is set within the range of ±20% with respect to the width of the magnet wire 40, and thereby, alignment of the magnet wires 40 in the respective turns overlapping without gaps may be reliably approached.

It is preferable that the projecting portion 95 is provided along the winding direction of the body 36. According to the configuration, the projecting portion 95 is provided along the winding direction of the body 36, and thereby, the projecting portion 95 is put against the magnet wire 40 at winding and stable winding may be performed.

The section of the body 36 has a rectangular shape. The projecting portion 95 extends in the winding direction of the body 36. The projecting portion 95 is provided on the short side of the body 36. It is preferable that the length of the projecting portion 95 in the winding direction of the body 36 is within a range from 30 to 90% of the length of the short side of the body 36. According to the configuration, the length of the projecting portion 95 in the winding direction of the body 36 is set within the range from 30 to 90% of the length of the short side of the rectangular shape, and thereby, alignment of the magnet wires 40 in the respective turns overlapping without gaps may be reliably approached.

The projecting portion 95 projects in a position adjacent to the concave portion 90. Note that “adjacent” here includes not only the case where the projecting portion 95 and the concave portion 90 are in contact but also the case without contact. The projecting portion 95 faces the body 36. The projecting portion 95 connects to the body 36. The projecting portion 95 facilitates the start of winding of the first turns of magnet wire 56 (see FIG. 12). The projecting portion 95 guides the first turns of magnet wire 56 and the second turns of magnet wire 58 (see FIG. 13). The ends of the first turns and second turns of magnet wires 56, 58 on the second flange part 38 side are in contact with the projecting portion 95. According to the configuration, deformation of the second turns of magnet wire 58 to follow the bending shape of the first turns of magnet wire 56 may be relaxed. Further, production of gaps between the magnet wires 40 may be suppressed and the magnet wires 40 can be aligned in the respective turns overlapping without gaps. Furthermore, the displacement between the first turns of magnet wire 56 and the second turns of magnet wire 58 is expanded by the inclination of the projecting portion 95, and stably winding may be performed.

The outer circumference part, i.e., the edge part of the projecting portion 95 may be round-chamfered (rounded) and a curve may be provided. It is desirable that the curve is formed to have a radius from 0.3 to 0.6 mm. That is, when the magnet wire 40 is wound around the body 36, the part of the projecting portion 95 with which the magnet wire 40 is bent in pressure contact is rounded. In the embodiment, rounding refers to processing of a corner part of a sharp edge into a gently curved domed shape, i.e., round-off processing.

In the embodiment, the outer circumferential edge of the projecting portion 95 is rounded. The part (outer circumferential edge) is the part in which the bending magnet wire 40 is in pressure contact with the projecting portion 95 when the wiring wire 40 is wound around the body 36.

As described above, in the part in which the bending magnet wire 40 is in pressure contact with the projecting portion 95, tension of the magnet wire 40 is concentrated on the pressure contact point, and it is highly likely that the insulation coating of the magnet wire 40 breaks in the part. Accordingly, the part (outer circumferential edge) is rounded so that the edge may be curved and domed, and thereby, the contact area between the magnet wire 40 and the projecting portion 95 becomes larger and pressing force generated by the contact is dispersed.

That is, in a projecting portion not rounded, the insulation coating of the magnet wire may be broken on the acute angle of the outer circumferential edge part, however, in the rounded projecting portion 95, the contact area of the part in which the outer circumferential edge and the insulation coating of the magnet wire 40 are in contact becomes wider and breakage of the insulation coating covering the magnet wire surface is prevented.

Note that the rounded part is not limited to the above described part, but may be appropriately selected according to the shape of the projecting portion 95 or the part may be rounded only partially. That is, the rounded part may be any combination of parts as long as the purpose of protecting the magnet wire 40 may be achieved.

The distance between the inner side surface of the first flange part 37 and the inner side surface of the second flange part 38 of the bobbin 26 is an integral multiple of the diameter of the magnet wire 40. The magnet wire 40 may be in close contact along the inner side surfaces of both of the flange parts 37, 38. Therefore, regular winding of the magnet wire 40 can be preferably performed. The regular winding refers to a winding method of spirally winding the first turns of single magnet wire, then, winding the second turns, and the third and subsequent turns are wound in the same manner.

The pair of flange parts 37, 38 are fixed to the body 36 so that the inner side surfaces may be nearly parallel. Regarding the pair of flange parts 37, 38, the inner side surfaces are nearly parallel, and the distance between the inner side surfaces is equal to the length of the body 36 and an integral multiple of the diameter of the magnet wire 40 over the whole circumference.

Here, “nearly parallel” is defined to include a configuration of crossing in a range within 10 degrees in addition to the configuration in completely parallel.

The shape of the bobbin 26 is fabricated by injection molding of PPS resin or the like. Note that the material of the bobbin 26 may be not only the PPS resin but also Noryl, PA (polyamide), PBT (polybutylene terephthalate), PETP (polyethylene terephthalate), PC (polycarbonate).

According to the embodiment, winding irregularities in the winding start part of the magnet wire 40 in both directions of the axis direction of winding and the direction orthogonal thereto may be reduced by the concave portion 90. Further, the projecting portion 95 projects by the amount of displacement between the first turns of magnet wire 56 and the second turns of magnet wire 58, and deformation of the second turns of magnet wire 58 to follow the bending shape of the first turns of magnet wire 56 may be relaxed. Furthermore, production of gaps between the magnet wires 40 may be suppressed and the magnet wires 40 can be aligned in the respective turns overlapping without gaps, and the bobbin 26 that enables easier regular winding may be provided.

### Method of Manufacturing Coil Bobbin

FIGS. 12 to 14 show fabrication steps of the coil bobbin 50 according to the embodiment. FIG. 12 shows a state of a magnet wire 96 in an introduction part and the first turns of magnet wire 56 at the start of winding, FIG. 13 shows a state of the second turns of magnet wire 58 one turn before the last, and FIG. 14 shows a completed winding state of the second turns of magnet wire 58.

The method of manufacturing the coil bobbin 50 according to the embodiment includes a step of inserting the magnet wire 40 into the concave portion 90 and a step of winding the magnet wire 40 around the projecting portion 95.

The method of inserting the magnet wire 40 into the concave portion 90 according to the embodiment is performed at the following steps.

First, the bobbin 26 is set in a winding machine (not shown).

Then, as shown in FIG. 12, the magnet wire 96 in the introduction part is inserted (held) into the concave portion 90 along the shape of the bobbin 26.

The method of winding the magnet wire 40 around the projecting portion 95 according to the embodiment is performed at the following steps.

First, as shown in FIG. 12, the magnet wire 40 is brought into contact with the projecting portion 95 of the bobbin 26. Thereby, the projecting portion 95 of the bobbin 26 is put against the first turns of magnet wire 56 with an appropriate force, and therefore, the position of the bobbin 26 is determined and the optimal width of the body 36 in the axis direction of winding according to the integral multiple of the diameter of the magnet wire 40 may be obtained.

Then, as shown in FIG. 12, the magnet wire 40 is wound around the body 36 and the first turns of magnet wire 56 is formed (a winding step of the first turns).

Then, as shown in FIGS. 13 and 14, the magnet wire 40 is wound on the first turns of magnet wire 56 and the second turns of magnet wire 58 is formed (a winding step of the second turns). In this regard, as shown in FIG. 13, the part one turn before the last of the second turns of magnet wire 58 does not drop out by the projecting portion 95.

Further, as shown in FIG. 14, the part of the last turn of the second turns of magnet wire 58 does not drop out because the part one turn before the last is located in the predetermined location, and regular winding may be performed without dropout. In this regard, the width of the body 36 of the bobbin 26 in the axis direction of winding is a dimension accurately corresponding to the integral multiple of the diameter of the magnet wire 40, and the regular winding may be easily performed.

According to the embodiment, winding of the second turns of magnet wire 58 may be smoothly performed, and efficient winding operation may be performed without stoppage of the winding machine. Thereby, the method of manufacturing the coil bobbin 50 with higher performance and higher efficiency may be provided.

Further, the motor 4 with higher performance and higher efficiency having the advantages by the above described coil bobbin 50 may be obtained. As a result, the robot 100 with higher performance and higher efficiency having the advantages by the above described motor 4 may be provided.

Note that, in the embodiment, the projecting portion 95 provided in the second flange part 38 is explained, however, the same projecting portion as the projecting portion 95 may be provided in the first flange part 37. According to the configuration, the projecting portion projects by the amount of displacement between the first turns of magnet wire 56 and the second turns of magnet wire 58, and thereby, deformation of the second turns of magnet wire 58 to follow the bending shape of the first turns of magnet wire 56 may be relaxed. Further, production of gaps between the magnet wires 40 may be suppressed and the magnet wires 40 can be aligned in the respective turns overlapping without gaps.

As above, the embodiment of the invention is explained based on the several examples, however, the above described respective embodiments of the invention are for facilitating understanding of the invention, not limiting the invention. The invention may be changed or improved without departing from the scope and claims and the invention includes equivalents thereof.

The robot of the invention is explained based on the illustrated embodiments, however, the invention is not limited to those. The configurations of the respective parts may be replaced by arbitrary configurations having the same functions or other arbitrary configurations may be added.

In the above described embodiments, the surface as a plane (surface) to which the robot (base) is fixed is a plane (surface) parallel to the horizontal plane, however, the invention is not limited to that. For example, the surface may be a plane (surface) inclined with respect to the horizontal plane or vertical plane or parallel to the vertical plane. That is, the rotation axis (first axis AX1) may be inclined with respect to the vertical direction or horizontal direction or parallel to the horizontal direction.

The robot of the invention is not limited to the horizontal articulated robot. The same advantages may be obtained with a vertical articulated robot, parallel link robot, or dual-arm robot. Further, the robot of the invention is not limited to the six-axis robot. The same advantages may be obtained with a robot of seven or more axes or five or less axes. Furthermore, the robot of the invention is not limited to the arm-shaped robot (robot arm), but may be another type of robot e.g. a legged walking (running) robot or the like as long as it is provided with an arm.

The entire disclosure of Japanese Patent Application No. 2016-146028, filed Jul. 26, 2016 and 2016-128520, filed Jun. 29, 2016 are expressly incorporated by reference herein.

What is claimed is:

1. A robot comprising:
a first member;
a second member provided rotatably with respect to the first member; and
a motor that transmits drive force from one to the other of the first member and the second member,
wherein the motor has
a stator having a bobbin and a winding wire wound around the bobbin, and
a rotor rotatably attached to the stator, regarding the motor,
a power supply voltage is within a range from 48 to 60 V,
a wire diameter of the winding wire is within a range from 0.45 to 0.75 mm.

2. The robot according to claim 1, wherein a number of turns of the winding wire is within a range from 29 to 44.

3. The robot according to claim 1, wherein output of the motor is within a range from 50 to 600 W.

4. The robot according to claim 3, wherein, when the output of the motor is within a range from 50 to 300 W, the wire diameter of the winding wire is within a range from 0.45 to 0.55 mm, and the number of turns of the winding wire is within a range from 29 to 43.

5. The robot according to claim 3, wherein, when the output of the motor is within a range from 100 to 600 W, the wire diameter of the winding wire is within a range from 0.65 to 0.75 mm, and the number of turns of the winding wire is within a range from 34 to 44.

6. The robot according to claim 1, wherein a sum of a length of the first member and a length of the second member is equal to or less than 400 mm.

7. The robot according to claim 1, being a scalar robot.

8. The robot according to claim 1, being a multi-axis robot.

9. A motor comprising:
a stator having a bobbin and a winding wire wound around the bobbin; and
a rotor rotatably attached to the stator,
wherein, regarding the motor,
a power supply voltage is within a range from 48 to 60 V,
a wire diameter of the winding wire is within a range from 0.45 to 0.75 mm.

10. The motor according to claim 9, wherein a number of turns of the winding wire is within a range from 29 to 44.
